(19) United States
(12) Patent Application Publication
(10) Pub. No.: US 2026/0280663 A1
(43) Pub. Date: Sep. 17, 2026

(54) Method and Apparatus for Improving Land MobileRadio (LMR) Base Site Coverage Using Sectorized Antenna

(71) Applicant: MOTOROLA SOLUTIONS, INC., CHICAGO, IL (US)

(72) Inventors: DENNIS DREES, DEER PARK, IL (US); DAVID P GURNEY, CARPENTERSVILLE, IL (US); KEVIN DOBERSTEIN, WOODSTOCK, IL (US); GREGORY J BUCHWALD, CRYSTAL LAKE, IL (US); JEFFREY F THURSTON, LAKE ZURICH, IL (US)

(21) Appl. No.: 19/076,307

(22) Filed: Mar. 11, 2025

(51) Int. Cl. H04B 7/06; H04B 7/024

(52) U.S. Cl. CPC H04B 7/0691; H04B 7/024

(57) ABSTRACT

Land mobile Radio (LMR) system coverage and reliability levels are improved through the application of wide beamwidth sectorized antennas and various transmission/reception techniques. Simulcast transmission methods from a single LMR base site using the sectorized antennas improve outbound coverage and reliability levels. Sectorized antennas are also utilized in combination on the base station receiver side to improve inbound coverage and reliability levels. The net effect of these improvements is a significant reduction in the number of LMR sites needed to cover a given area, which in turn reduces LMR system deployment, maintenance and operational costs.

This application MSI Docket PAT32372 (serial number xx,xxx,xxx) is related to application MSI docket PAT32373 (serial number yy,yyy,yyy) both assigned to Motorola Solutions, Inc. and filed of even date.

### BACKGROUND

Land Mobile Radio (LMR) service is deployed for a wide range of users, including public safety users, critical infrastructure/utility users (e.g., electric, gas, oil), and manufacturing/enterprise users. Many users (or groups of users or agencies) make use of wide-area systems, such as county or state-wide systems. System deployment cost is typically driven by the amount of covered area(s) that are required for the LMR system. In addition, critical functions like public safety and related LMR systems often require very high (e.g., 95% or higher) covered area communications reliability levels, which further increases LMR system cost. In addition, several LMR customers desire to have in-building coverage, which must overcome significant propagation losses from (typically) outdoor base stations. Thus, methods that increase the covered area per base site, and/or increase the reliability of the LMR system are beneficial to both users and system owner/operators.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 shows a graphical representation of typical omni antenna pattern distortion when mounted on a tower.

FIG. 2 shows a land mobile radio (LMR) communication system utilizing sectorized antennas formed and operating in accordance with some embodiments.

FIG. 3 shows an example comparison of antenna patterns for a typical cellular sectorized antenna and an improved LMR base site sectorized antenna for a three-sector base site in accordance with some embodiments.

FIG. 4 shows an example of a deployment of three-sector high gain, wide beamwidth LMR base site, with sectorized antennas also described at FIG. 2, in accordance with some embodiments.

FIG. 5 is a high level functional diagram of a sectorized LMR base site, such as the base site of FIG. 4, in accordance with some embodiments.

FIG. 6 shows a functional block diagram of subsite sector racks with corresponding antennas, such as those deployed in each subsite of the LMR base site of FIG. 5, in accordance with some embodiments.

FIG. 7 shows an example of a multi-stage embodiment of an LMR system formed and operating in accordance with some embodiments.

FIG. 8 illustrates the effective antenna gains from cross-sector combining in accordance with some embodiments.

FIG. 9 illustrates an example of utilizing a combination of receiver combining and comparator selection techniques in the LMR base site receiver in accordance with some embodiments.

FIGS. 10 and 11 summarize steps for implementing and controlling a transmitter side and a receiver side of an LMR base site in accordance with some embodiments. Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Traditional base sites utilize omni-directional antennas to simplify system design. High gain omni antennas are typically utilized to increase site coverage area (or conversely reduce the number of LMR base sites that are required to cover a given area). However, limitations on the physical height of practical omni antenna packages and the vertical beamwidth effectively limit the achievable gain of omni antennas. For example, physical antenna height is typically limited to around 21 feet, to make mounting the antenna on an LMR tower practical. In addition, the minimum allowable vertical (elevation) pattern half-power beamwidth (HPBW) of the antenna may be limited to 3-4 degrees, to avoid undue signal losses near the LMR tower. These and other factors (e.g., antenna weight, wind load, etc.) combine to effectively limit achievable omni antenna gain to around 11.5 dBd in practice.

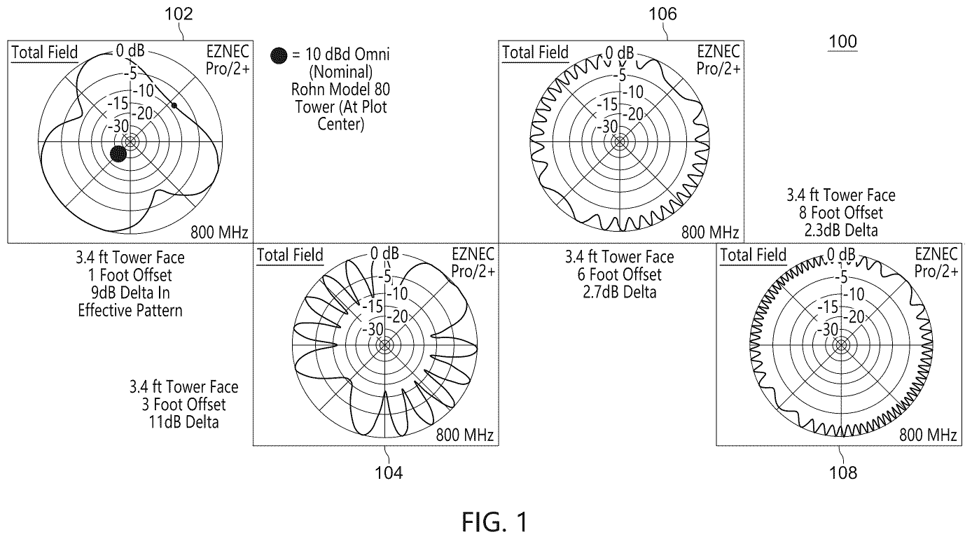

In addition, the interaction of the base site antenna with the tower itself (and nearby structures) often distorts the ideal antenna pattern. FIG. 1 shows a graphical representation 100 of the pattern distortion for a typical 10 dBd omni antenna when mounted at varying distances (or offsets) from a tower with a 3.4 foot face (e.g., using an antenna standoff, as shown in 102, 104, 106, 108). For a normalized omni antenna pattern, the pattern distortion often appears as several dB of ripple on the ideal circular pattern (see FIG. 1, where ripple is noted as the pattern ‘delta’ value associated with the degradation from the ideal circular or omni antenna pattern). For example, graph 102 represents a 3.4 foot (ft) tower face with a 1 ft antenna offset having a 9 dB variation (or delta) in effective pattern, graph 104 represents a 3.4 foot (ft) tower face with a 3 ft offset having an 11 dB delta in effective pattern, graph 106 represents a 3.4 foot (ft) tower face with a 6 ft offset having an 2.7 dB delta in effective pattern, and graph 108 represents a 3.4 foot (ft) tower face with an 8 ft offset having an 2.3 dB delta in effective pattern.

The amount of pattern distortion is often related to the distance of the antenna from the (metal) tower structure, and other related structures in the area. These effects can negatively impact LMR site coverage, particularly in certain directions. In fact, it is fairly common to see shadowing effects from the LMR tower (e.g., on the other side of the tower) in the field. If there are additional structures around the LMR antennas (such as other metal rigging, other antennas, buildings, beacons, etc.), the omni antenna pattern can be distorted even further. In addition, these detailed structures and their effects are often very difficult to simulate, which may result in incorporating additional design margin (e.g., higher transmit power levels, more LMR base sites, etc.) to overcome these types of real-world effects to improve LMR system reliability and coverage levels.

All of the above effects limit the effective gain and coverage areas of traditional LMR base sites. System reliability is also negatively impacted by these factors. Note that these effects hold true even for variations of omni antenna patterns, such as A, B or H omni-like pattern antennas (for example dbSpectra DS7M13PDAU-Series Antennas designed by DB Spectra, Inc.).

Typical LMR base stations may be licensed to transmit several hundred watts of effective radiated power (ERP), depending on the base site location. In general, ERP level is defined as the (conducted) power level delivered to the antenna (after all cable, filtering and other processing losses) multiplied by the antenna gain (in linear terms), and is often limited by governmental or local regulations (such as the FCC in the United States, or local or regional coordination bodies). Thus, the licensed ERP transmission level limit for a particular LMR base site, and even the ERP limits in particular geographic directions may in turn contribute to limiting the maximum achievable coverage area of the site. In such cases, it may be desirable to better control RF emissions in particular directions. The use of omni or omni-like antenna patterns generally make achieving geographically shaped emissions difficult.

In other cases, other factors (further described herein) may limit LMR system coverage area and reliability levels. In addition, since LMR power amplifiers (PAs) often have delivered output power limitations (due to cost, size, weight, power, linearity requirements, and other factors), the achievable antenna gains with omni type antennas may also limit the coverage and reliability levels in an LMR radio system. Related factors in LMR transmitters, like combiner losses in the base site transmitter, may further limit the delivered power level to antennas, in turn requiring higher antenna gains, or even higher PA power output levels (which may or may not be achievable, due to the limitations mentioned above). Note that a combiner is generally utilized to isolate different transmission channels from each other, and combine multiple signals together to enable transmission on a single antenna (while reducing unwanted RF emissions). Combiners typically take up appreciable rack space to implement.

One method that may be utilized in LMR transmission systems to improve coverage and system reliability is simulcast transmissions. In this approach, multiple geographically distinct LMR base sites typically transmit the same time-aligned (or nearly time-aligned) signal, on the same channel(s), to mobile and portable (i.e., subscriber) radios in the system (on the outbound, or base station to subscriber radio link). For example, if there are ten (10) LMR base sites deployed in a system, all 10 (or a smaller number) of the base sites may transmit identical signals on the outbound link. If a particular signal from one LMR base station is shadowed (e.g., by terrain, clutter, foliage, buildings or other structures), an alternate outbound signal path from another LMR base station may be less shadowed (and available), generally improving the reliability and coverage of the outbound signal and the LMR system. Simulcast transmission has the net effect of providing diverse outbound signal paths, and increasing the signal to noise ratio at the subscriber radio for the outbound signal.

While such techniques may improve system outbound coverage and reliability levels, the inbound (i.e., subscriber radio to base station) link often limits the overall achievable LMR system coverage area, since portable or subscriber radios are often transmit power limited (e.g., to 3 watts ERP in the US 800 MHz LMR band). This in turn limits the achievable inbound coverage and reliability levels of the LMR system. While mobiles can transmit at higher ERP levels, they are often well below typical LMR base station ERP levels. LMR mobiles and portable devices also typically employ much lower gain (or even lossy) antennas, due to cost and size limitations (which further hinders both reception and transmission, and LMR system coverage levels). For example, some portable LMR devices employ stubby quarter wave antenna structures, which become highly lossy when portable LMR radios are worn on the belt or used in the hand. Similarly, covert radio systems may utilize hidden or disguised antennas that may be inefficient and lossy. Battery life considerations in portable devices also limits the achievable PA power levels, which in turn affects the achievable ERP levels for those devices, and in turn negatively affects the inbound coverage and reliability levels in an LMR system. So, a wide variety of factors can reduce LMR system coverage areas.

One approach to improve LMR system inbound coverage and reliability levels is to employ diversity reception or receiver combining techniques at the base station, which often require two (or more) receive antennas to be deployed at the base site. Typically, only one or two omni antennas are traditionally implemented at the LMR base site. These antennas suffer from the same practical gain, size, weight, cost, pattern distortion, and wind load limitations as the LMR base site transmit antennas described above, which in turn limits the LMR system coverage and reliability levels.

Accordingly, there is a need for a method, system, and apparatus to improve LMR system coverage and reliability levels.

Briefly, there is provided herein an approach to providing improved LMR system coverage and reliability levels through the incorporation of wide beamwidth sectorized antennas, in accordance with various embodiments. LMR system coverage and reliability levels are significantly improved by using high gain, wide beamwidth sectorized antennas, along with several transmission and reception techniques, as will be described in the various embodiments. The improved approach utilizes simulcast transmission techniques from a single LMR base site using sectorized antennas to further improve outbound coverage and reliability levels, while sectorized antennas can also be utilized in combination on the base station receiver side to greatly improve inbound coverage and reliability levels. The net effect of these improvements is a significant reduction in the number of LMR sites required to cover a given area, which in turn reduces LMR system deployment, maintenance and operations costs for customers.

Claims for this application PAT32372 (US Serial Number xx,xxx,xxx) are directed primarily to the transmit side and system, while claims to the receiver perspective and system are provided in PAT32373 (US serial number yy,yyy,yyy). Docket PAT32373 is incorporated by reference with PAT32372.

One embodiment viewed from the transmit side provides a method for implementing a land mobile radio (LMR) transmitter base site. The method comprises: deploying a plurality of wide beamwidth sectorized antennas radially spaced to form overlapping regions of RF coverage around the LMR transmitter base site; operating at least one transmitter function at the LMR transmitter base site; generating, via the at least one transmitter function, one or more simulcast transmission signals, each simulcast transmission signal being configured with an independent launch time adjustment; applying an independent dithering sequence to each of the one or more simulcast transmission signals as part of the transmitter function; and transmitting each of the one or more simulcast transmission signals based on each independent launch time adjustment and each independent dithering sequence, with each simulcast transmission signal being transmitted over a respective wide beamwidth sectorized antenna of the plurality of wide beamwidth sectorized antennas associated with each overlapping region of RF coverage, thereby providing a simulcast LMR transmitter base site.

In general, dithering refers to the application of phase or frequency shifts, or a combination thereof, applied to the transmitted signal. The phase or frequency shift may be a combination of one or more of: a programmable fixed phase shift to at least one simulcast transmission signals of each sector, a programmable frequency offset between two or more of the simulcast transmission signals, or a time-varying sequence of phase or frequency components to the carrier signal of one or more of the simulcast transmission signals. The dithering sequences may be applied at any point during the modulation/transmitter function (e.g., to a baseband signal, onto an IF or RF carrier, during local oscillator generation, etc.). For example, a band limited phase noise dithering sequence may be applied to the I and Q components of the transmitted signal. In other embodiments, a random phase noise sequence may be added to a local oscillator in the transmitter function, to achieve the desired effect. In yet other embodiments, a frequency dithering sequence may be applied to the signal that is to be frequency modulated in the transmitter.

Another embodiment provides a land mobile radio (LMR) base site, described from the transmit perspective. The land mobile base site comprises: a transmitter; a base site controller; a wide beamwidth sectorized transmit antenna operatively coupled to the transmitter, the wide beamwidth sectorized transmit antenna being radially spaced relative to other sectorized antennas of the LMR base site, to form overlapping sectors of LMR RF coverage around the LMR base site. The base site controller further comprises a microprocessor configured to: operate a transmitter function on the LMR transmitter during the transmit mode of operation; generate, in response to the transmitter function, one or more simulcast transmission signals, each simulcast transmission signal being configured with an independent launch time adjustment for each sector of the overlapping sectors; apply, as part of the transmit function, an independent dithering sequence to each of the one or more simulcast transmission signals; transmit each of the one or more simulcast transmission signals based on each independent launch time adjustment and each independent dithering sequence, with each simulcast transmission signal being transmitted over the receive wide beamwidth sectorized antenna associated with each of the overlapping sectors of LMR RF coverage, thereby providing a portion of a simulcast LMR base site transmitter.

A further embodiment provides a method for implementing a land mobile radio (LMR) base site, from the receive perspective. The method comprises deploying a plurality of wide beamwidth sectorized antennas radially spaced to form overlapping regions of LMR RF coverage around the LMR receiver base site, wherein the plurality of wide beamwidth sectorized antennas comprise a plurality of antenna elements configured to receive inbound LMR RF signals; operating at least one receiver function including a receiver combining function, on the plurality of antenna elements associated with the plurality of wide beamwidth sectorized antennas at the LMR receiver site, to generate a group of intermediate outputs for the LMR receiver base site; and applying a comparator function on the group of intermediate outputs to generate an LMR base site receiver output. Antenna elements may comprise either a single polarization of a wide beamwidth sectorized antenna, or multiple polarizations (e.g., cross-polarized) of a wide beamwidth sectorized antenna. The receiver function may be capable of receiving (and demodulating) a single RF channel, or multiple channels (e.g., simultaneously).

Another embodiment provides a land mobile radio (LMR) base site, from the receive perspective. The LMR base site comprises: a receiver; a base site controller having a microprocessor; a wide beamwidth sectorized receive antenna operatively coupled to the receiver. The microprocessor of the base site controller is configured to: operate a receiver function including a receiver combining function, on one or more elements associated with the wide beamwidth sectorized antenna, to generate a group of intermediate outputs; and apply a comparator function on the group of intermediate outputs to generate an LMR base site receiver output.

Each of the above-mentioned embodiments will be discussed in more detail below, starting with example system and device architectures of the system in which the embodiments may be practiced, followed by an illustration of processing blocks for achieving an improved technical system, method, and device for a land mobile radio base site.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

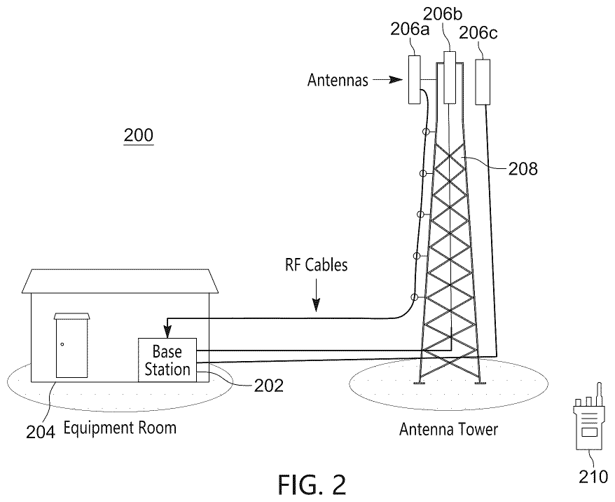

FIG. 2 shows a land mobile radio (LMR) communication system 200 formed and operating in accordance with some embodiments. The LMR communication system 200 comprises a base station 202, such as may be located in an equipment room 204 or coupled to some external structure, the base station including RF power amplifier(s), receiver(s), and other circuitry, which may be mounted to equipment racks (discussed later). The base station 202 is coupled, such as via individual electronic cabling, to a plurality of wide beamwidth sectorized antennas radially spaced around the tower 208. In this example, three sectorized antennas, 206a, 206b, 206c are located at, or near, the top of a tower 208 (although they may be located at any level on the tower or building in practice). A radio, such as portable radio 210 (or a vehicular/mobile radio) having push-to-talk (PTT) functionality may communicate with other similar radios within the LMR communication system 200, which may consist of multiple LMR base sites.

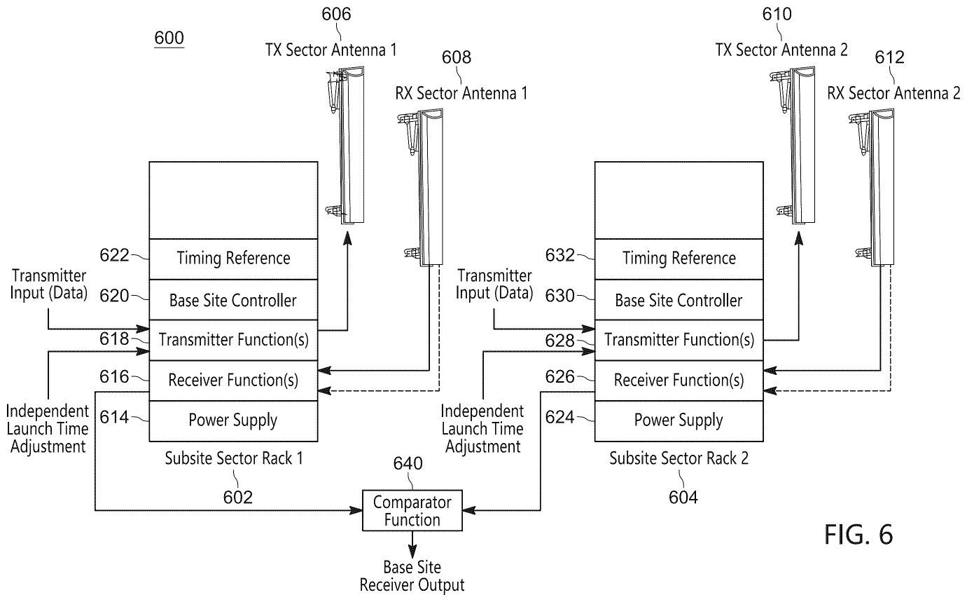

The plurality of wide beamwidth sectorized antennas may be configured to exhibit a half-power beamwidth of at least the radial spacing of the sectorized antennas. The radial spacing refers to angles configured to align with the antenna pointing angle (or antenna boresight). In the example embodiment of FIG. 2, the sectorized antennas 206a, 206b, 206c, of communication system 200 are each configured for at least a 120 degree horizontal half power beamwidth (HPBW), thereby forming three-sector (3-sector) RF coverage around the tower 208. It should be appreciated that any number of sectors could be deployed at the LMR base site to accomplish the coverage and reliability goals. For example, a border site only covering a 240 degree arc (or less) may only deploy two (2) wide beamwidth sectorized antennas. In general, for the same physical antenna length as an omni antenna, a sectorized (120 degree HPBW) antenna can practically realize about 5 dB more gain due to the directionality of the main lobe. In other cases, the radial sector spacing may be more or less than 120 degrees (e.g. for a 3 sector site). For example, one could set the sectorized antenna pointing angles to 0 degrees, 100 degrees, and 200 degrees, in order to increase the overlap between sectors in particular directions. While FIG. 2 shows three single antennas, each having combined transmit/receive functionality (such as operated via a duplexer), it is appreciated that two separate antennas, one for transmit and one for receive may be deployed per sector, such as will be described later in conjunction with FIG. 6. The transmit antenna are typically placed lower on the tower than the receive antennas.

In accordance with some embodiments, the sectorized antennas 206a, 206b, 206c are configured for a high gain, wide horizontal beamwidth, and a broad gently sloping antenna pattern, in order to increase the overlapping regions among sectors in the LMR system. This approach is opposed to traditional cellular sectorized panel antennas, which have much faster signal reduction/roll-off beyond the antenna boresight (i.e., much narrower half-power beamwidth), in order to minimize inter-sector interference among users in each sector (as described illustrated below).

In accordance with some embodiments, the wide beamwidth sectorized antennas may be deployed with reduced radial spacing between sectorized antennas to increase inter-sector overlap, which in turn increases the transmit and receive combining effects. For the example of FIG. 2, the wide beamwidth sectorized antennas 206a, 206b, 206c are configured for a half-power wide beamwidth of at least the sector spacing (e.g. 120 degrees, for a 3-sector site). It is however possible to deploy four or more of such antennas at a LMR base site (with increased overlap between sectors), or utilize wider or narrower antenna beamwidths, within limits. In general, if there is a critical coverage area in the LMR system deployment (e.g., where in-building coverage or increased range is desirable), it is advantageous to utilize increased overlap among sectors in those areas (as further explained herein). As few as one or two antennas may also be deployed at a sectorized LMR site in some cases, for example, if only covering a segment of the area around the base station.

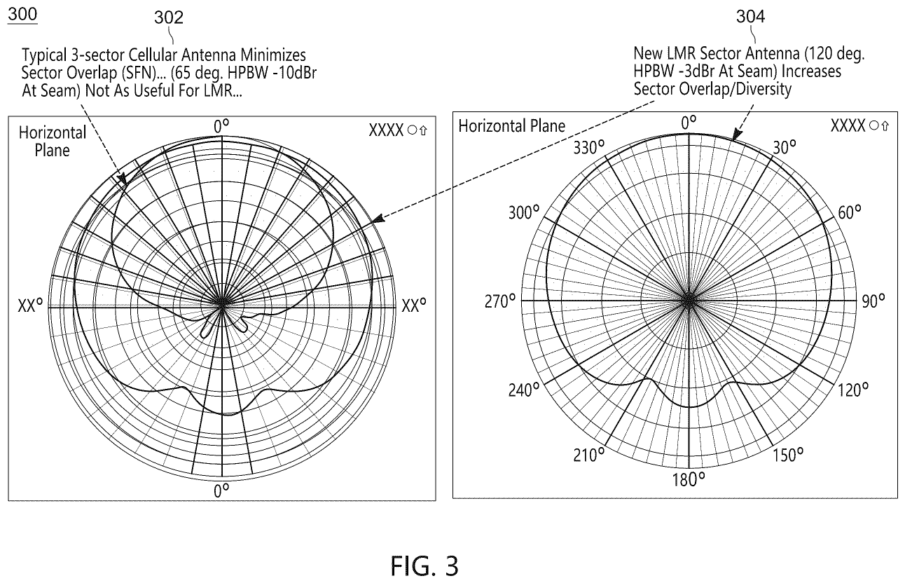

The configuration of wide beamwidth sectorized antennas operating in accordance with the various embodiments, largely eliminates the pattern distortion concerns at the LMR base site which were noted at FIG. 1, and which will be discussed in FIG. 3. In general, as long as the front-back (F/B) ratio of the sectorized antenna is greater than a predetermined minimum value (e.g., 15 dB), the negative effects of the tower and other objects behind the tower will be minimized, resulting in much more uniform antenna patterns in practice (from the combined effects of the sectorized antennas at a base site). Similarly, the directional nature of the sectorized transmit and receive antennas helps to minimize multipath reflections from more distant objects in the back half of the antenna pattern, reducing the overall multipath distortion and signal variations.

FIG. 3 shows an example comparison of antenna patterns 300 for a typical cellular sectorized antenna 302 and an improved LMR base site wide beamwidth sectorized antenna 304 for a 3-sector base site, such as the three sector base site provided by FIG. 2. For a 3-sector LMR base site, the LMR sectorized antenna provided greater than 15 dBd of antenna realized in practical sector antennas, with a horizontal half power beamwidth (HPBW) of about 120 degrees. In this case, the antenna gain at the sector seams (at +/−60 degrees, for an antenna pointing at 0 degrees) is −3 dBr (relative to the boresight antenna gain). The angles of radial spacing are configured to align with the antenna pointing angles (or antenna boresights, e.g., at 0 degrees, 120 degrees, and 240 degrees). By contrast, a typical cellular sectorized panel antenna for a 3-sector cellular site would only typically have a much narrower 65 degree horizontal HPBW, and be approximately −10 dBr at the sector seam (to minimize inter-sector interference with adjacent sectors, in order to maximize system capacity). Note that implementing increased antenna pattern overlap in cellular system sectorized antennas would cause increased interference between different users in different sectors of a cell. Thus, the goals in deploying sectorized antennas in LMR systems (where inter-sector antenna pattern overlap is significantly increased to order to increase system range and reliability) are very different than cellular systems (where inter-sector antenna pattern overlap is minimized to increase overall system capacity).

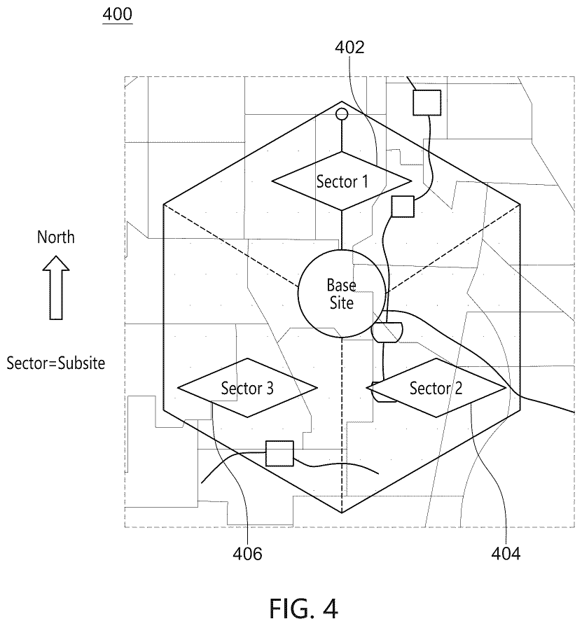

FIG. 4 shows an example of a deployment of a three-sector wide beamwidth LMR base site 400 deployed using sectorized antennas, such as those described at FIG. 2, in accordance with some embodiments. In this case, a northern sector 402 is pointed at 0 degrees (relative to true north at 0 degrees). A second sector 404 is pointed at 120 degrees (SE), and a third sector 406 is pointed at 240 degrees (SW). This case covers the three 120 degree horizontal HPBW antennas spaced 120 degrees radially around the tower. The actual radial spacing around the tower may be varied in some cases (e.g., some sectors may be spaced by 130 degrees, while others may be spaced by 110 degrees) without any loss of generality. Note that this approach supports using either a single antenna for both base site transmission and reception (e.g., a single T/R antenna with a duplexer), or separate transmit and receive antennas, as is often done in LMR systems. For the purposes of maximizing both inbound and outbound coverage, both the transmit and receive antennas are preferably high gain, wide beamwidth sectorized antennas.

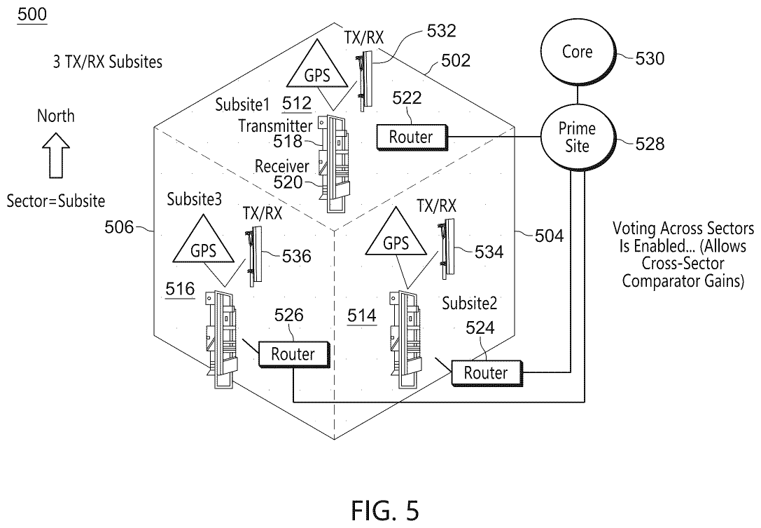

FIG. 5 is a high level functional diagram 500 of a sectorized LMR base site, such as the base site of FIG. 4, in accordance with some embodiments. Each sector 502, 504, 506 is managed by a dedicated (or partially dedicated) rack of transceiver (transmitter and receiver) equipment 512, 514, 516, which may also be referred to as a subsite. That is, a subsite may be utilized to implement each sector (and the terms may be used interchangeably for this discussion). Subsite 1 includes a transmitter 518 and a receiver 520 as part of the transceiver equipment 512. The transmitter 518 and receiver 520 of subsite 1 are operatively coupled to a wide beamwidth sectorized antenna 532, which may be a single transmit/receive (TX/RX) wide beamwidth sectorized antenna (as shown), or a separate transmit sector antenna and receive sector antenna, such as shown at FIG. 6 (by transmit sector antenna 606 and receive sector antenna 608). Similar equipment arrangements may be deployed for sectorized antenna 534 of subsite 2 and sectorized antenna 536 of subsite 3.

In accordance with some embodiments, a combination of receiver combining (i.e., received signal combining) techniques are deployed, along with simulcast transmissions from each sector (as detailed below). These reception techniques may include a combination of maximum ratio combining, equal branch combining, weighted combining and/or selection diversity techniques. The weighted combining function may be complex, and chosen to reduce a resulting interference level (e.g., by cancelling an interfering signal through destructive addition of two or more receiver branches), or to increase a desired signal to noise ratio (e.g., by weighing receiver branches with higher signal quality more heavily). For example, maximum ratio combining may be utilized with the two inputs from a cross-polarized high gain wide beamwidth sectorized receive antenna (antenna elements within a sector), and selection diversity techniques (e.g., a comparator or voting function) may be utilized across the different sectors (e.g., as shown in FIG. 6). The comparator results of the sectorized LMR base site may then be combined with other LMR base sites (sectorized or not) to arrive at a final voted output for the received signal from subscriber radios. This processing may occur at a prime (or centralized) site 528, or the processing may occur locally at each site (in a first stage), which is in turn further combined with receiver results from other sites at a centralized site in a second stage (as described below). Routers 522, 524, 526 communicate with prime site 528 managed by core 530 interoperating with respective routers and equipment (518 and 520) operating within each sector. The connections between the routers and the prime site 528 are typically considered backhaul (e.g., wide area network or point-to-point) connections. The prime site 528 may be co-located to the base site or located somewhere else. The prime site 528, may perform second stage voting (across different LMR base sites), for example. In addition, the routers utilized for each sector may be combined (e.g., in a switch or another router) to result in a single connection to the prime site 528.

Several embodiments of this approach are possible without any loss of generality. For example, one, two or more sectors could be deployed at a particular sectorized LMR base site, and the receiver combined results from each sector and/or site may be combined across two or more (e.g., geographically separate) LMR base sites. The various sectors and sites may be combined in any order desirable, or processed in multiple stages. In another example, four (4) sectors may be deployed at an LMR base site, using the same high gain wide beamwidth antennas as described above (further increasing the overlap and diversity effects between sectors). In addition, the receiver combining approach may employ maximum ratio combining across sectors or antenna elements (e.g. across like antenna polarizations of adjacent sectors, instead of within a sector), and then be further diversity combined (e.g., using max ratio or selection diversity techniques) across sectors and potentially antenna polarizations at the LMR base site, or with receiver results from other LMR sites. Note in general that antenna elements may comprise different polarizations (e.g. of the same sectorized antenna package) or different antenna structures (e.g., polarization or polarizations) of neighboring sectors.

In accordance with some embodiments, an LMR base site may be configured for a single sector for transmit mode. For example, subsite 1 of FIG. 5 may comprise a transmitter, a base site controller, and a wide beamwidth sectorized transmit antenna operatively coupled to the transmitter.

In this embodiment, the wide beamwidth sectorized transmit antenna is radially spaced relative to other sectorized antennas at the LMR base site, such as subsite 2 and subsite 3, to form overlapping sectors of LMR RF coverage around the LMR base site. In accordance with this embodiment, the base site controller comprises a microprocessor configured to: operate a transmitter function on the LMR transmitter during the transmit mode of operation. In response to the transmitter function, the transmitter generates one or more simulcast transmission signals. Each simulcast transmission signal may be configured with an independent launch time adjustment for each sector of the overlapping sectors. The base site controller further applies, as part of the transmit function, an independent dithering sequence to each of the one or more simulcast transmission signals. Each of the one or more simulcast transmission signals is transmitted, by the transmitter based on each independent launch time adjustment and each independent dithering sequence. Each simulcast transmission signal is transmitted over the wide beamwidth sectorized antenna associated with each of the overlapping sectors of LMR RF coverage, thereby providing a portion of the aggregate simulcast LMR base site transmitted signal. The plurality of simulcast transmission signals (from each sector) helps to significantly improve the received signal at the subscriber location (due to the diversity of paths between the base station transmitter and subscriber receiver, which helps to combat channel effects such as Rayleigh fading). This aggregate signal from the LMR base station gets further combined with simulcast transmission signals from other base stations, to further improve the received signal quality.

Continuing with the LMR base site configured for transmit, the wide beamwidth sectorized antenna may be configured for half-power beamwidths of at least the radially spacing of the overlapping sectors of LMR RF coverage. A phase or frequency shift, may be applied via the transmit function, to at least one of the independent dithering sequences of the one or more simulcast transmission signals. The phase or frequency shift may be applied to the independent dithering by applying one of: a programmable fixed phase shift to at least one simulcast transmission signals of each sector, a programmable frequency offset between two or more of the simulcast transmission signals, or a time-varying sequence of phase or frequency components to the carrier signal of one or more of the simulcast transmission signals. In some embodiments, the wide beamwidth sectorized antenna used for transmission may also be used for reception at the LMR base site. An effective radiated power (ERP) level may be independently adjusted for each of the overlapping sectors of LMR RF coverage to control RF emissions in predetermined directions. An independent adjustment to a downtilt of the wide beamwidth sectorized transmit antenna may also be used to control RF emissions within the overlapping sectors of LMR RF coverage. The transmitter of the LMR base site may be implemented with a multi-carrier power amplifier (PA). The transmitter of the LMR base site may further be implemented as a combiner-less multi-carrier power amplifier PA.

While this single sector embodiment has been described from the perspective of the transmitter and a single antenna, the LMR base site may also provide operation for both transmit and receive modes of operation, wherein the wide beamwidth sectorized transmit antenna used for transmission may also be used for reception at the LMR base. Alternatively, implementations using a second wide beamwidth sectorized receiver antenna in conjunction with the transmit sectorized antenna may also be deployed.

Another embodiment may be provided for the case of a single sector, single antenna for an LMR base site configured for receive mode. For example, subsite 1 of FIG. 5 may comprise LMR base site comprising a receiver; a base site controller, and a wide beamwidth sectorized receive antenna operatively coupled to the receiver. In this embodiment, the wide beamwidth sectorized receive antenna is radially spaced relative to other sectorized antennas at the LMR base site, such as located at subsite 2 and subsite 3. In accordance with this embodiment, the base site controller comprises a microprocessor configured to: operate a receiver function on elements associated with the wide beamwidth sectorized antenna to generate a group of intermediate outputs, and to further apply s comparator function on the group of intermediate outputs to generate an LMR base site receiver output.

While this single sector embodiment has been described from the perspective of the receiver and a single antenna, the LMR base site may also provide operation for both receive and transmit modes of operation, wherein the wide beamwidth sectorized antenna used for reception may also be used for transmit at the LMR base site (such as shown by the TX/RX antennas in FIG. 5). Alternatively, implementations using a second antenna, the second antenna being a wide beamwidth sectorized transmit antenna in conjunction with the receiver antenna may also be deployed.

If diversity reception antennas (or elements/polarizations) are not deployed at the LMR site, and the receiver combining function is employing selection diversity techniques (or other combining techniques), the other unused receiver input (or branch) may be terminated or connected to ground to effectively form a pass-through function for the receiver function. (This operationally transforms the receiver function for each sector into a single branch receiver.) Likewise, if the receiver combining function is performing a maximum ratio or coherent combining across all branches (e.g., antennas or polarizations) at the LMR base site, the comparator function may only operate on a single input (for that site), and output that value or stream. In some embodiments, the receiver combining techniques that are employed may be further adapted to improve link budgets (e.g., by performing coherent combining or interference cancellation across antennas, polarization, or LMR base sites), depending on other system factors.

An example of the non-diversity case in accordance with some embodiments is provided while still referring to FIG. 5. In this example, the land mobile radio (LMR) site 500, comprises prime site controller 528, and first and second subsites, such as subsite 1 and subsite 2, configured for the case of non-diversity reception. For the non-diversity reception case, the first subsite may comprise a first LMR base site deployed with a single transmit/receive (TX/RX) vertically-polarized wide beamwidth sectorized antenna. The single TX/RX vertically-polarized wide beamwidth sectorized antenna may be operatively coupled through a duplexer coupled to a transmitter (518) and a receiver (520) of the first LMR sector (502). The second subsite may comprise a second LMR sector deployed with a second single transmit/receive (TX/RX) vertically-polarized wide beamwidth sectorized antenna. The second vertically-polarized wide beamwidth antenna may be operatively coupled through a second duplexer coupled to a transmitter and a receiver of the second LMR sector (504).

In this non-diversity embodiment, the prime site controller comprises a processor configured to initiate one of: (1) a receiver combining function comprising a selection diversity technique based on a first input to the first receiver (from the sectorized antenna, through the duplexer); and a termination to GND of the second receiver input, thereby performing a pass-through function which operationally transforms the receiver function for each subsite into a single branch receiver; or (2) a receiver combining function comprising a maximum ratio combining across both of the first and second receivers; and (2) a comparator function on only one receiver input of the first and second receivers of the first and second and output a corresponding value or stream. The comparator function may be chosen to minimize an overall error rate, or maximize a resulting signal to interference plus noise ratio of the output stream (which may in turn be converted to a composite received bit stream, for further processing).

FIG. 6 shows a lower level functional block diagram 600 of subsite sector racks with corresponding antennas, such as those deployed in each subsite of the LMR base site of FIG. 5, in accordance with some embodiments. Note that in FIG. 6, only two sectors of equipment are shown for clarity (e.g., subsite sector rack 602, used for implementing subsite 502, and subsite sector rack 604, used for implementing subsite 504, respectively), although any number of subsites or sectors may be implemented at an improved LMR base station. Each of the first and second subsite sector racks 602, 604 includes first and second wide beamwidth sectorized transmit (TX) and receive (RX) antennas, associated with each sector at the LMR base site.

First subsite sector rack 602 operates in conjunction with a first transmit wide beamwidth sector antenna 606 and a first receive wide beamwidth sector antenna 608. Second subsite sector rack 604 operates in conjunction with a second transmit sector antenna 610, and a second receive sector antenna 612.

One, two or more sectors may be implemented at the LMR base site, depending on the desired sector coverage. For an LMR base site with omni-directional coverage needs, implementation of three (3) sectors is particularly advantageous in terms of achieving high sectorized antenna gains and significant transmitter and receiver combining effects to further increase the effective antenna gains in the LMR system, thereby further increasing the coverage and reliability levels around the improved LMR base site and in the overall system. While FIG. 6 shows separate transmit and receive sectorized antennas, it is appreciated that other embodiments might utilize a duplexer to combine the transmit and receive signals onto one sectorized antenna (per sector).

The first subsite sector rack 602 provides a power supply 614, a receiver 616 providing receiver function(s), and a transmitter 618 providing transmitter function(s), all operatively managed by a base site controller 620 and timing reference 622. The second subsite sector rack 604 similarly provides a power supply 624, a receiver 626 providing receiver function(s), and a transmitter 628 providing transmitter function(s), all operatively managed by a base site controller 630 and timing reference 632. The second subsite sector rack 604 may operate similarly to the first subsite sector rack 602.

In accordance with some embodiments, the first subsite sector rack 602 provides the multicarrier PA/transmit function 618, which may combine multiple LMR RF carriers into a single transmit signal for each sector. The receiver function 616 may be implemented as a diversity capable receiver performing maximum ratio combining of the receive signals (e.g., across two or more receive polarizations, elements or antenna(s)). For example, one way to efficiently implement the receiver system is to utilize a cross-polarized sectorized receive antenna (that receives both polarizations within a single antenna package). In this case, each sectorized receive antenna would typically have two receive RF lines coming from it into the receiver function (e.g., 616, 626), where the two channels would be combined to form a single receiver output. Note that while cross-polarization (e.g., slant or +/−45 degree) is mentioned here, other orthogonal or nearly orthogonal polarizations (e.g., horizontal and vertical polarization, or right-hand circular polarization and left-hand circular polarization, etc.) could be employed in the sectorized antenna.

In other embodiments, where receive diversity may not be implemented within a sector, there may only be a single receive signal line from the receive sector antenna (which may utilize any polarization, including a vertical polarization). In both cases, the demodulated signal from each receiver function may be fed into a comparator (or voter) function, to combine the receiver results across sectors. The comparator function may reside, in part, locally, or at the prime site, as described above.

The transmitter functions (618, 628) for each sector may be capable of generating one or more RF signals (e.g., modulated narrowband carriers) with independent launch time adjustments and independent dithering sequences for each sector (as further described below). As mentioned, the dithering sequences may be applied at any point during the modulation/transmitter function (e.g., to a baseband signal, onto an IF or RF carrier, during local oscillator generation, etc.). For example, a band limited (e.g., Gaussian based) phase noise dithering sequence may be added to the I and Q components of the transmitted signal. In other embodiments, a random (e.g., uniform or Gaussian) phase noise sequence may be added to a local oscillator in the transmitter function, to achieve the desired effect. In yet other embodiments, a frequency dithering sequence (perhaps bi-modally distributed) may be applied to the signal that is to be frequency modulated in the transmitter. The transmit RF signals are then sent to the respective sectorized transmission antenna. As mentioned, setting the front-back ratio of the sector antenna above a minimum predetermined value (e.g., 15 dB F/B ratio, based on the modulation type) generally results in much more uniform transmission (and reception) patterns around the improved LMR base site. The F/B ratio compares the antenna gain in a specified direction (in the antenna boresight) to the gain in a direction 180 degrees from the antenna boresight, the F/B ratio being expressed in decibels (dB).

The base site controller 620 generally controls all of the functions of the site or subsite, and may alternatively be centralized across the subsite sectors. Similarly, the timing reference function 622 may be performed commonly across the sectors (within limits described later). The transmitter function (e.g., 618, 628) is further described below. The various functional blocks in the rack may communicate freely with each other through a backplane contained in the rack (or even across racks using analog or digital cabling—not shown). The base site controller 620 is typically connected to a site or subsite router (as was depicted in FIG. 5 at 522, 524, 526), which is used to communicate the inbound and outbound signals for one or more RF channels, as well as control related base site/sector functions.

Redundancy may be implemented in other functions shown in system 600, with fail-over capability to backup functions. Thus, fewer or more receiver functions, transmitter functions, timing references, base site controllers, etc. may be employed at the site 600, depending in part on the desired level of redundancy at the site.

The second subsite sector rack 604 is configured similarly to first subsite sector rack 602 In an alternative embodiment, each subsite sector rack 602, 604 may be configured differently (e.g., tuned to differing transmit power levels, or utilizing different levels of receiver combining functions) based on contextual elements known to be located within a sector, for example a building located in a first sector and a wide open parking lot or field in second sector. In other words, the tuning of each subsite sector rack 602, 604 may be independent based on environmental context of the desired coverage area.

It is appreciated that there are different possible implementations of the functionality at a typical LMR base site. For example, in cases where a multicarrier PA/transmitter function is not available, individual PA/transmitters may be utilized for each RF carrier that is transmitted from the site, and the signals from each of those PA/transmitters may be sent to a single antenna using a combiner function, the combiner function being known in the art. The combiner function typically consists of cavity filters and circulators, and is outside of the scope of this description. In other cases, a multi-carrier receiver function may be employed that simultaneously demodulates several RF channels (and may also include diversity reception or receiver combining functionality). Similarly, receive multi-couplers, signal splitters, pre-amplifiers, tower top amplifiers, filters, etc. are not shown in the FIG. 6 (to enhance clarity), but may be present in some implementations, without departing from the scope of the invention.

At a high level view, in the receiver system, the inbound RF carrier signal is/are received at the base site receiver via sectorized receiver antenna(s). The incoming RF signal is then demodulated by the receiver function where a receiver combining function (e.g., maximum ratio combining) is performed prior to, or as part of the demodulation process, and the comparator (or voting) function is performed after at least partial demodulation of the received signal. In the transmitter system, the input signal to the transmitter function for each sector, and an outbound RF simulcast signal is generated for each sector, with independent dithering sequences and launch time adjustments being applied as part of the transmitter function.

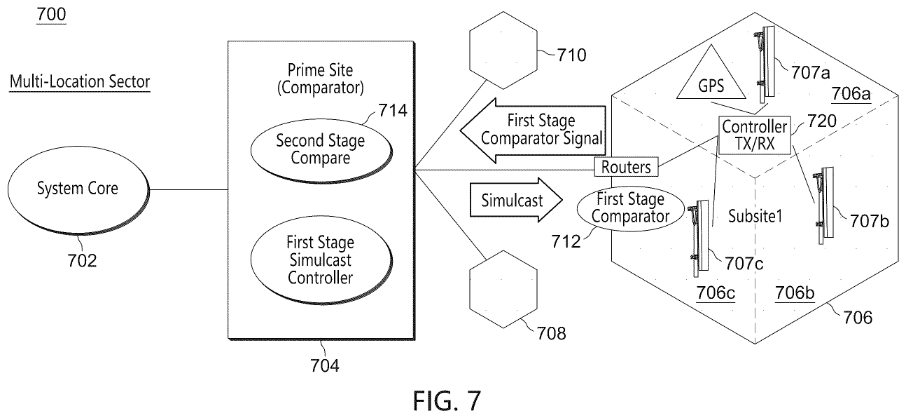

FIG. 7 shows an example of a multi-base site deployment of an LMR system 700 formed and operating in accordance with some embodiments. In this system, there are multiple LMR base sites (e.g., 706, 708, 710) utilized to cover a given area. The LMR system 700 also comprises a system core 702 (e.g. server or overall LMR system controller) operating in accordance with a public safety standard, for example an ASTRO Project 25 (P25) standard, the Digital Mobile Radio (DMR) standard, the Terrestrial Trunked Radio (TETRA) standard, or the like, used by public safety agencies, industrial or enterprise customers for critical two-way communications. A prime site 704 operates in accordance with the standard set by the system core 702. The prime site 704 may receive (inbound) user data from, and sends (outbound) user data to, one or more base sites, shown in this embodiment as base sites 706, 708, 710. User data may comprise voice data or other digital data of any type (e.g., user locations, photos, video, data files, databases, computer aided dispatch data, etc.). Each base site 706, 708, 710 may comprise a plurality of sectorized antennas, each sectorized antenna providing RF coverage for its respective sector. For example, sectorized antennas (TX and RX antennas) 707a, 707b, 708c respectively provide RF coverage for each sector 706a, 706b, 706c of base site 706 are controlled by a base site controller, transmit function(s), receive function(s), located on sector rack 720. In this embodiment, a single combined rack of equipment is shown within base site 706 (which may include multicarrier PAs and multicarrier receivers) and may include a base site controller which manages transmit and receive functions for the sectorized antennas 707a, 707b, 707c.

A multi-stage comparator system may be utilized in this approach, that includes a first stage comparator function 712 applied across the local base site receiver outputs from each sector (sectors 706a, 706b, and 706c). In this case, the first stage comparator 712 is operated across each sector 706a, 706b, 706c of base site 706 to form intermediate outputs for the LMR base site. Each sector may optionally, in turn, utilize maximum ratio combining within a sector on two or more polarizations of the sectorized receive antennas. In this case, maximum ratio combining is applied on two or more polarizations of the sectorized receive antennas within each sector 706a, 706b, 706c of RF base site 706 to generate a first stage comparator output signal. The first stage comparator signal is input to a second stage of comparator processing at prime site 704, as described next. This has the effect of reducing the backhaul bandwidth utilized by the LMR base site (e.g., by a factor of 3) for user data. It also helps to limit the number of inputs that the comparator function needs to support (e.g., at the prime site).

The multi-base site system 700 may apply a second stage comparator function 714 at the prime site 704 across different (e.g., geographically distinct) LMR base sites, such as base sites 708, 710, with those sites utilizing sectorized or non-sectorized approaches. The comparator function 714, whether implemented for a single LMR base site, or across LMR base sites, may take into account received signal strength indicators (e.g., RSSI), signal to interference plus noise ratios (e.g., SINRs), forward error correction information (e.g. FEC soft or hard information, or error level/SINR estimates or metrics from one or more FEC or block-codes used within a slot), and other factors, across the different comparator inputs. In general, the comparator function 714 will attempt to output the input branch (e.g., demodulated bit stream from the receiver function) with the lowest bit error rate, highest signal strength, or related metrics per sample or sub-sample. The comparator function 714 may also eliminate input branches from consideration if they have long delays (typically due to backhaul limitations). The comparator function 714 may also operate at a high rate, and make several different selections or decisions per timeslot (or subscriber transmission period). In one embodiment, the comparator function 714 utilizes soft error correction information from several block codes within a slot in order to choose the best reception data stream within multiple sub-slots or sub-samples during the timeslot (in an attempt to minimize the resulting BER of the received signal). The comparator 714 then forms a final output for the subscriber transmission, utilizing several different possible forms of decision criteria (as described above).

The net effect of these types of example approaches is that very significant comparator gains are achieved between sectors at an LMR site, due not only to the receiver combining within a sector (e.g., utilizing maximum ratio combining across a cross-polarized high gain wide beamwidth sectorized receiver antenna), but also the comparator gains of choosing the best receiver results across sectors, to achieve further significant gains (e.g., due to voting across sectors) in a first stage, and then optionally realizing further multi-site comparator gains (e.g., by voting across sites) in the larger LMR system. The diversity gains are made possible in part through the large amount of overlap in the high gain, wide beamwidth sectorized antennas that are employed at each site (and across sites). Similar transmit diversity (or transmission path) gains are achieved through simulcast transmissions from each sector (and across sites) in the LMR system, as further described below. All of these effects help to significantly improve the LMR system coverage and reliability levels, and lower system deployment and operational costs.

On, the transmit side, the prime site 704 may further provide provisions for independently tuning the transmit signal launch times (described above) for each sector (e.g., 706a, 706b, 706c) or site (e.g., 708, 710) in the system. This allows a system designer to carefully tune the delay spread environment in the LMR system, and avoid self-interference from simulcast transmissions. Similarly, the transmitter function utilized for each sector (e.g., 618, 628 of FIG. 6) supports independent dithering sequences to be utilized for each sector (e.g., 706a, 706b, 706c) or site (e.g., 708, 710) in the system, to help avoid destructive interference in the LMR system. Furthermore, a programmable fixed phase or frequency offset may be applied to the transmitted signal of each sector (e.g., 706a, 706b, 706c) or site (e.g., 708, 710) in the system, to provide additional means to address self-interference from simulcast transmissions.

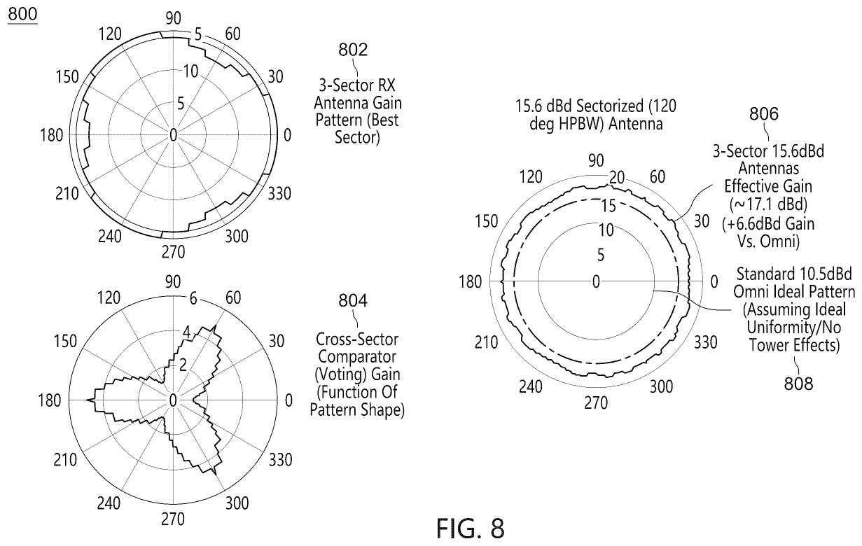

FIG. 8 shows graphical representations of the combined and effective antenna patterns for a sectorized LMR receive site (e.g., 706). In this case, receiver diversity is not deployed within each sector (e.g., in cases where a cross-polarized receive antenna may not be fully utilized, such as in LMR sites that do not employ maximum ratio combining). The achievable comparator gains shown are based on 15.6 dBd wide beamwidth sectorized panel antennas at the LMR receive site (e.g., 706) when compared to a traditional high gain 10.5 dBd omni antenna. These results are based on single branch receivers being employed in each sector of a 3-sector RF base site, and a specific 15.6 dBd 120 degree HPBW (e.g., high gain wide beamwidth) sectorized receive antenna pattern. In this case, the LMR sectorized panel antenna itself has about 5.1 dB more gain than the omni antenna, and the three (3) sectors are oriented at above at 0 degrees, 120 degrees, and 240 degrees as shown in graph 802. Graph 802 thus represents a combined 3-sector (or best sector) antenna pattern for the receive sectorized antenna.

Graph 804 shows the additional effective antenna gains being realized when considering the comparator (voting) gains across sectors (termed the ‘cross-sector diversity gain’), which increases the sectorized panel antenna effective gains even further (by about 1.5 dB beyond the 5.1 dB mentioned above). These gains are highly dependent on the actual antenna pattern of each sector that is employed, and generally increase as the HPBW of each sector increases.

Graph 806 shows the net effective antenna gain being the sum of the combined 3-sector receive (RX) antenna pattern 802 plus the cross-sector diversity/voting gains shown at graph 804. The combined effective antenna gain, is shown by roughly circular pattern 806, as compared to a more traditional 10.5 dBd omni antenna pattern 808. The net effective gain of the sectorized antennas at the LMR base site is around 17.1 dBd in this example (with the comparator combining effects across sectors resulting in about 1.5 dB of average gain over the baseline sectorized antenna gain). Note that the exact amount of effective antenna gain is a function of the actual sectorized antenna (e.g., gain and pattern) that is deployed, and the antenna patterns and cross-sector diversity gains shown at graphs 802, 804, 806 vary based on the actual sectorized antenna pattern of the individual sectors. The highest cross-sector diversity gains are achieved in the areas of the combined pattern with the largest amount of overlap (or in areas or directions with similar antenna gains). This type of diversity/voting (across sectors) with high gain wide beamwidth sectorized antennas (as above) may result in a roughly 50% improvement of the effective coverage area of the LMR base site (e.g., approximately a 50% improvement in the 95% reliability covered area) in some cases, compared to the use of a traditional stand-alone high gain (10.5 dBd) omni antenna. Unlike traditional diversity methods used in cellular systems (which are typically applied across antennas covering the same sector or coverage areas), the diversity/voting methods provided by the embodiments described herein are typically applied across different sectors at an LMR base site to harness additional desired signal energy.

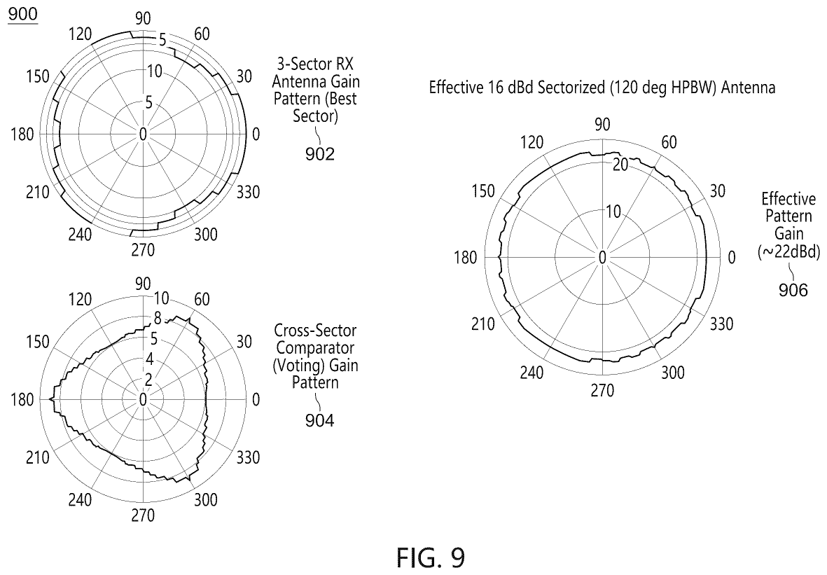

FIG. 9 illustrates an example of utilizing the combination of receiver combining and comparator selection techniques in the LMR base site receiver in accordance with some embodiments. Further implementing receiver combining within a sector (e.g., when utilizing cross-polarized sector antennas or multiple receive antennas) can result in further significant gains. For example, if maximum ratio combining is implemented using a cross-polarized sectorized antenna (e.g., respectively within each sector), and then a comparator function (voting) is applied across sectors, a 16 dBd sectorized antenna can achieve an effective antenna gain of roughly 22 dBd (due to the combination of the max ratio combining in the receiver and the cross-sector diversity techniques at an LMR base site), resulting in even further coverage area and reliability improvements. FIG. 9 illustrates a graphical example of effective sectorized antenna gain with receive diversity in accordance with some embodiments when using sectorized 16 dBd antennas with 120 degrees HPBWs. In this case, each sector has a higher effective gain due to the maximum ratio combining performed in the receiver function (e.g., within a sector), which is further increased by comparator gains (e.g., due to voting) across the sectors at an LMR site.

Alternative embodiments may apply voting across most or all sectors and/or antenna polarizations available at a site, which would also result in significant effective antenna gains (although not as large as coherently combined diversity techniques, as described above). These combined antennae gain effects result in much greater LMR system coverage and reliability from an LMR site. Even further combining and diversity gains may be achieved by combining results across LMR sites, as described above.

Other possible combinations of diversity are possible, without any loss of generality (as mentioned above) and without departing from the scope of the invention. For example, maximum ratio combining may be performed across two or more receiver branches (e.g., 3 or 4 branch maximum ratio combining), either within a sector and/or across sectors, and then voting (selection diversity) may be performed across those resulting receiver outputs, to form a diversity combined result (e.g., across sectors, different LMR sites, etc.). The inputs to the receiver combining function may also be dynamically switched (e.g., either within a sector or across sectors), depending on other factors (such as subscriber device location, or inbound RSSI across sectors or antenna polarizations). In this manner, the effective diversity gains in the system can be quite large, resulting in greatly improved LMR inbound coverage areas and reliability levels. The performance gain may be maintained or enhanced by applying a large amount of overlap between sectors and sites in the LMR system.

Now focusing on the LMR base site transmitter side, each sector's transmitter function (e.g., modulator and PA) preferably supports independent adjustments of the launch time, which is utilized to optimize the delay spread environment (in a particular geographic direction) in a simulcast system. Launch times may be adjusted over a 100 microsecond (or more) window (e.g., in one microsecond steps), to fine tune the synchronization of the simulcast signals transmitted across different LMR sectors and sites, in order to minimize the delay spread seen across the system.

Having too much delay spread (or differential delay) from simulcast signals can hinder LMR system performance, and is generally undesirable. Such tuning generally takes into account the distance between sites, the modulation type utilized, and the signal strengths of the transmitted signals from various sectors and sites, at any given location within the LMR system.

The main advantage of transmitting multiple simulcast signals (e.g., across overlapping sectors or sites) is that transmit diversity gains (nominally equal gain combining) are achieved at the mobile or portable receiver antenna, which can be very significant (since the transmitted signals may constructively combine at the receiver to improve coverage and reliability levels). Using the described techniques, multiple simulcast signals can be transmitted from a single improved LMR base site. Multiple LMR base sites in the system (using either sectorized or non-sectorized/omni antennas) can also transmit simulcast signals to further improve outbound coverage and reliability. As long as the LMR base site sector antennas are adequately physically spaced apart (e.g., by 5 wavelengths or more horizontally), the fading effects across the different transmitted signal paths should be uncorrelated, resulting in significant gains in faded channels (as described). These same uncorrelated signal path effects apply to each sector of the LMR base site receive antennas (for the signal transmitted from the subscriber device), such that significant diversity gains may be achieved at the base site (as described above).

and preferably) apply independent phase dithering (or other related techniques, such as random frequency offsets) to the individual sector's transmitted signal, in order to help break up destructive self-interference that may occur in simulcast systems. Each of the generally random phase dithering sequences (or frequency offset sequences) may be further modified (e.g. with differing/programmable fixed phase, frequency offset, or time varying phase/frequency offset sequence values) to better control inter-sector self-interference in the system. This approach gives a large amount of flexibility when setting launch time delays and transmitted sector signal overlap in the system, and further improves outbound LMR system coverage and reliability. For example, random phase noise sequences may be applied as a dithering sequence in the transmitter, and further combined with a fixed or time-varying frequency offset sequence to further break up destructive interference in a simulcast system. Note again that the transmitter function utilized in a sector may support the generation of multiple narrowband RF carriers (or channels) in the system, if a multicarrier PA is utilized, and a common dithering function may be applied to the simulcast signal transmitted from each sector.

Finally, each sector's effective radiated power level may be independently adjusted, to better control LMR base site RF emissions in particular directions (e.g., in order to meet neighboring system's interference contour limits, as prescribed by a local, regional, or nationwide regulatory body). Similarly, each sector's downtilt may be independently adjusted to better tailor the more distant RF emissions of the LMR base site. As another advantage of the sectorized LMR base station approach, the high gain of the base site sector antennas will result in lower required PA output power levels (either lower transmitter power output (TPO) levels, or lower top-of-rack (ToR) power levels) to achieve a given ERP level, especially if a combiner-less multicarrier PA architecture is utilized. This allows higher ERP levels to be more practically achieved in a sectorized LMR base site approach.

In combination, the above described sectorized LMR base site techniques greatly improve both inbound and outbound coverage and reliability for LMR sites and systems. This in turn can translate into lower LMR system deployment costs (e.g., fewer deployed LMR base sites), as well as lower LMR system operational costs (e.g., site maintenance, site leasing, site utility/HVAC costs, etc.). In addition, the described sectorized LMR base site approach offers improved system redundancy (compared to a traditional omni type antenna LMR base site), since even if a particular sector fails for any reason (e.g., due to an antenna or cable failure, PA failure, receiver failure, etc.), other sectors will fill in the LMR coverage area (albeit at reduced levels).

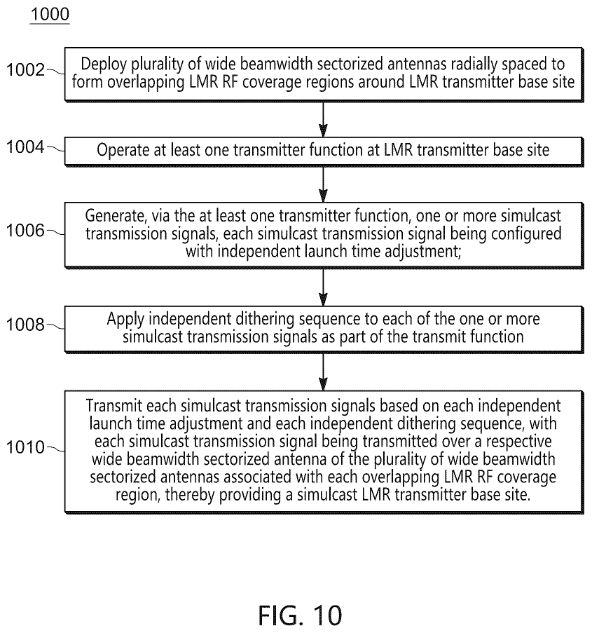

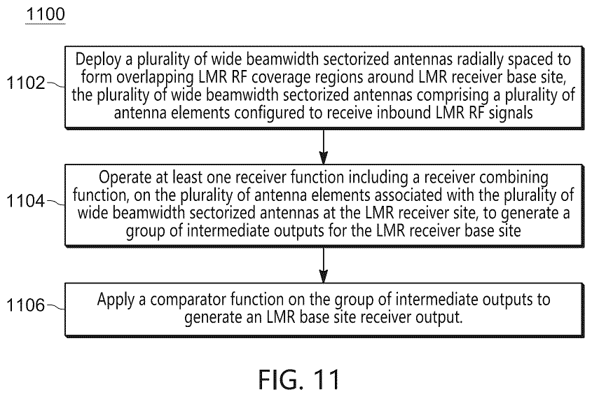

Two flowcharts are shown in FIGS. 10 and 11 to summarize steps for implementing and controlling a transmitter side and a receiver side of an LMR base site. in accordance with some embodiments. The two sides are described independently, to recite the individual and independent adjustments which may be taken.

FIG. 10 provides a method 1000 for implementing a land mobile radio (LMR) transmitter base site, in accordance with some embodiments. Method 1000 begins at 1002 by deploying a plurality of wide beamwidth sectorized antennas radially spaced to form overlapping regions of LMR RF coverage around the LMR transmitter base site. The plurality of wide beamwidth sectorized antennas may be configured to exhibit a horizontal half-power beamwidth of at least the radial spacing of the sectorized antennas. At 1004, the method continues with operating at least one transmitter function at the LMR transmitter base site. The method continues to 1006 with generating, via the at least one transmitter function, one or more simulcast transmission signals, each simulcast transmission signal being configured with an independent launch time adjustment. The method continues to 1008 with applying an independent dithering sequence to each of the one or more simulcast transmission signals as part of the transmit function. The method then proceeds to 1010 with transmitting each of the one or more simulcast transmission signals based on each independent launch time adjustment and each independent dithering sequence, with each simulcast transmission signal being transmitted over a respective wide beamwidth sectorized antenna of the plurality of wide beamwidth sectorized antennas associated with each region of overlapping RF coverage, thereby providing a simulcast LMR transmitter base site.

The method 1000 may further apply a phase shift, a frequency shift, or a time varying frequency or phase sequence via the transmit function, to at least one of the independent dithering sequences of the one or more simulcast transmission signals. The phase or frequency shift applied to the independent dithering sequence may further comprise applying one of: a programmable fixed phase shift to at least one simulcast transmission signals of each sector, a programmable frequency offset between two or more of the simulcast transmission signals; or a time-varying sequence of phase or frequency components to the carrier signal of one or more of the simulcast transmission signals. The method 1000 may further independently adjust an effective radiated power (ERP) level for each of the wide beamwidth sectorized antennas for each of the overlapping LMR sectors of RF coverage to control RF emissions in predetermined directions. The independent adjustment may comprise independently adjusting a downtilt of each of the wide beamwidth sectorized antennas to control RF emissions within each of the overlapping LMR RF coverage regions. The transmitter function may further comprise a multi-carrier power amplifier. The sectorized LMR base site may be implemented with a combinerless multi-carrier power amplifier.

As an example of the implementation of method 1000, and in conjunction with FIG. 6, two wide beamwidth sectorized antennas (606, 610) may be deployed at the LMR transmitter site (600) and operated using at least one transmitter function (618 and/or 628) for generating at least one simulcast transmission signal, each simulcast transmission signal with an independent launch time adjustment. For example, two or more simulcast transmission signals may be generated using the at least one transmitter function (at each subsite), and an independent (phase or frequency) dithering sequence may be applied into each of the respective simulcast transmission signals. Each of the two simulcast transmission signals are then transmitted over their respective wide beamwidth sectorized antenna (606, 610) associated with each overlapping RF coverage region, thereby providing a simulcast LMR transmitter base site.

FIG. 11 is a method 1100 for implementing an LMR receiver base site, viewed, in accordance with some embodiments. Method 1100 begins at 1102 with deploying a plurality of wide beamwidth sectorized antennas (e.g. antennas 608, 612 of FIG. 6) radially spaced to form overlapping regions of LMR RF coverage around the LMR receiver base site, the plurality of wide beamwidth sectorized antennas comprising a plurality of antenna elements configured to receive inbound LMR RF signals.

The method 1100 continues to 1104 with operating at least one receiver function (e.g. 616 and/or 626) including a receiver combining function, on the plurality of antenna elements (or a subset of the antenna elements) of the plurality of wide beamwidth sectorized antennas at the LMR receiver base site, to generate a group of intermediate outputs for the LMR receiver base site. The method continues to 1106 with applying a comparator function on the group of intermediate outputs to generate an LMR base site receiver output.

In some embodiments, the antenna elements may comprise, for example, a single polarization for each of the wide beamwidth sectorized antennas. The method 1100 may further comprise combining the LMR receiver base site outputs across multiple geographically distinct LMR receiver base sites to generate a LMR channel receiver final output. The combining of the LMR receiver base site outputs may further comprise performing a selective combining of the LMR base site receiver outputs using a comparator function (which may be part of the same or a different comparator function).

In some embodiments, at least one receiver combining function of 1106 may support at least one of: a selection function, a maximum ratio combining function, an equal gain combining function, and a weighted combining function determined to suppress interference, or increase a desired signal to interference ratio. The weighted combining function may comprise a weighting that suppresses interference. The weighted combining function further may comprise a weighting that increases a desired signal to noise ratio. In some embodiments, the comparator (or selection function) may further comprise performing a selection operation based on one of: a minimization of an output error rate, and a maximization of an input received signal strength level. In some embodiments the plurality of wide beamwidth sectorized antennas are configured to exhibit a horizontal half-power beamwidth of at least the radial spacing of the sectorized antennas.

In some embodiments, at least one of the plurality of wide beamwidth sectorized antennas may further comprise a cross-polarized sectorized antenna. In some embodiments, the receiver combining function comprises a maximum ratio combining across elements of a cross-polarized elements of the wide beamwidth sectorized receive antenna. In some embodiments, the receiver combining function further comprises a maximum ratio combining function across two or more of the wide beamwidth sectorized antennas.

In some embodiments, the receive LMR base site may be part of an LMR base site, the LMR base site providing for both receive and transmit modes of operation, wherein the plurality of wide beamwidth sectorized antennas used for reception are also used for transmission at the LMR base site. In accordance with some embodiments, the radial spacing to form the overlapping regions of LMR RF coverage is controlled by a half-power beamwidth (HPBW) of each of the plurality of wide beamwidth sectorized antennas.

Accordingly, there has been provided a sectorized LMR transmit site using wide beamwidth sectorized antennas. The sectorized wide beamwidth antennas are configured to provide independent simulcast dithering at each sector sub-site, which advantageously helps break up destructive interference. The additional of phase or frequency shifting of the dithering further allows controls and flexibility to avoid self-interference. The base site/antenna configuration may further provide for individual per sector tuning of launch time delays to optimize the delay spread environment. The LMR sectorization improves outbound coverage (outbound gain) due to: simulcast TX diversity gains across multiple sectors and improved radio site antenna pattern uniformity, and achieves higher ERP levels with the same transmit power output (TPO) or top of rack (ToR) power levels. Generally, ToR power levels refer to the power level measured (or computed) post combining and filtering of the transmitter function. In some embodiments, the plurality of wide beamwidth sectorized antennas generally exhibit a half-power beamwidth of at least the radial spacing of the sectorized antennas. In some embodiments, at least one of the plurality of wide beamwidth sectorized antennas further comprises a cross-polarized sectorized antenna, which may also be utilized for reception functions.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, (e.g., a human mind cannot transmit or receive electronic signals and cannot perform functions associated with an antenna, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for implementing a land mobile radio (LMR) transmitter base site, comprising:
deploying a plurality of wide beamwidth sectorized antennas radially spaced to form overlapping regions of RF coverage around the LMR transmitter base site;
operating at least one transmitter function at the LMR transmitter base site;
generating, via the at least one transmitter function, one or more simulcast transmission signals, each simulcast transmission signal being configured with an independent launch time adjustment;
applying an independent dithering sequence to each of the one or more simulcast transmission signals as part of the transmit function; and
transmitting each of the one or more simulcast transmission signals based on each independent launch time adjustment and each independent dithering sequence, with each simulcast transmission signal being transmitted over a respective wide beamwidth sectorized antenna of the plurality of wide beamwidth sectorized antennas associated with each overlapping region of RF coverage, thereby providing a simulcast LMR transmitter base site.

2. The method of claim 1, wherein the plurality of wide beamwidth sectorized antennas are configured to exhibit a horizontal half-power beamwidth (HPBW) of at least the radial spacing of the wide beamwidth sectorized antennas.

3. The method of claim 1, further comprising:
applying a phase or frequency shift, via the transmit function, to at least one of the independent dithering sequences of the one or more simulcast transmission signals.

4. The method of claim 3, wherein applying the phase or frequency shift to the independent dithering sequence further comprises applying one of:
a programmable fixed phase shift to at least one simulcast transmission signals of each region; or
a programmable frequency offset between two or more of the simulcast transmission signals.

5. The method of claim 1, wherein the LMR transmitter base site is part of an LMR base site that provides operation for both transmit and receive, and wherein the plurality of wide beamwidth sectorized antennas used for transmission are also used for reception at the LMR base site.

6. The method of claim 1, further comprising:
independently adjusting an effective radiated power (ERP) level for each of the wide beamwidth sectorized antennas for each of the overlapping regions of RF coverage to control RF emissions in predetermined directions.

7. The method of claim 1, further comprising:
independently adjusting a downtilt of each of the wide beamwidth sectorized antennas to control RF emissions within each of the overlapping regions of LMR RF coverage.

8. The method of claim 1, wherein the sectorized LMR base site is implemented with a combiner-less multi-carrier power amplifier.

9. The method of claim 1, wherein the transmitter function further comprises a multicarrier power amplifier.

10. A land mobile radio (LMR) base site, comprising;
a transmitter;
a base site controller;
a wide beamwidth sectorized transmit antenna operatively coupled to the transmitter, the wide beamwidth sectorized transmit antenna being radially spaced relative to other sectorized antennas of the LMR base site, to form overlapping sectors of LMR RF coverage around the LMR base site;
and
the base site controller having a microprocessor configured to:
operate a transmitter function on the LMR transmitter during the transmit mode of operation;
generate, in response to the transmitter function, one or more simulcast transmission signals, each simulcast transmission signal being configured with an independent launch time adjustment for each sector of the overlapping sectors;
apply, as part of the transmit function, an independent dithering sequence to each of the one or more simulcast transmission signals;
transmit each of the one or more simulcast transmission signals based on each independent launch time adjustment and each independent dithering sequence, with each simulcast transmission signal being transmitted over the wide beamwidth sectorized antenna associated with each of the overlapping sectors of LMR RF coverage, thereby providing a portion of a simulcast LMR base site transmitter.

11. The LMR base site of claim 10, wherein the wide beamwidth sectorized antenna has horizontal half-power beamwidths (HPBW) of at least the radial spacing of the overlapping sectors of LMR RF coverage 12. The LMR base site of claim 10, further comprising:
applying a phase or frequency shift, via the transmit function, to at least one of the independent dithering sequences of the one or more simulcast transmission signals.

13. The LMR base site of claim 12, wherein applying the phase or frequency shift to the independent dithering sequence further comprises applying one of:
a programmable fixed phase shift to at least one simulcast transmission signals of each sector; or
a programmable frequency offset between two or more of the simulcast transmission signals.

14. The LMR base site of claim 10, wherein the LMR base site provides operation for both transmit and receive modes of operation, and wherein the wide beamwidth sectorized antenna used for transmission is also used for reception at the LMR base site.

15. The land mobile base site of claim 10, further comprising:
independently adjusting an effective radiated power (ERP) level for each of the overlapping sectors of LMR RF coverage to control RF emissions in predetermined directions.

16. The land mobile base site of claim 10, further comprising:
independently adjusting a downtilt of the wide beamwidth sectorized antenna to control RF emissions within each of the overlapping sectors of LMR RF coverage.

17. The land mobile base site of claim 10, wherein the transmitter further comprises a multicarrier power amplifier.

18. The land mobile base site of claim 10, wherein the transmitter of the LMR base site is implemented with a combiner-less multi-carrier power amplifier (PA).

19. The land mobile base site of claim 10, further comprising:
a receiver;
a wide beamwidth sectorized receive antenna operatively coupled to the receiver;
the wide beamwidth sectorized receive antenna being radially spaced relative to other sectorized antennas at the LMR base site to form overlapping sectors of LMR RF coverage around the LMR base site; and
the microprocessor of the base site controller being configured to:
operate a receiver function including a receiver combining function, on at least one of the wide beamwidth sectorized antennas to generate a group of intermediate outputs; and
apply a comparator function on the group of intermediate outputs to generate an LMR base site receiver output.
